(19) United States
(12) Patent Application Publication
(10) Pub. No.: US 2013/0056159 A1
(43) Pub. Date: Mar. 7, 2013

(54) LOUVRE VANE SYSTEM

(71) Applicant: Andrew Gray, York (GB)

(72) Inventor: Andrew Gray, York (GB)

(21) Appl. No.: 13/695,698

(22) PCT Filed: May 4, 2011
(86) PCT No.: PCT/GB11/50870

§ 371 Date: Nov. 1, 2012

(30) Foreign Application Priority Data
May 4, 2010 (GB) 1007328.6

(51) Int. Cl. E06B 9/26; E06B 7/16; E06B 9/30

(52) U.S. Cl. 160/40; 160/176.1 R; 160/175; 160/168.1 R; 160/170

(57) ABSTRACT

The present invention relates to a louvre vane system with a frame, which houses a plurality of vanes within the frame. The vanes can be rotated between an open position, in which the edges of adjacent vanes are spaced apart and a closed position, in which the edges of adjacent vanes abut each other to for:: a substantially continuous surface. When the vanes are in the closed position, a thermal membrane, is formed by the, vanes 14 that prevents drafts and limits heat exchange from one side of the membrane to the other.

The present invention relates to a louvre vane system. In particular, it relates to a louvre vane system that can form a substantially continuous surface in a closed position.

### BACKGROUND/PRIOR ART

Louvre blinds, also known as Venetian blinds, which can be either horizontal or vertical, became popular in the 1700's. They are often made of flexible cloth but have also been made in metal, wood and plastic. They have been typically been used in dwellings to reflect sunlight while still allowing some light through, unlike a curtain. The blinds are typically used on windows and sky lights. Louvre blinds typically consist of a track and a number of vanes (sometimes referred to as slats, lamellae, strips or other terms) which can be rotated from an open position, where there is an air gap between the vanes, to a closed position, where there is normally an overlap of material to block most of the light getting through. This general principle has also been used in engineering applications where, for example, more rigid vanes have been pivoted from an open to a closed position to increase or reduce the airflow into an engine or heating system. Therefore the use of vanes, slats or strips of material to block light and reduce heat gain or air flow is well known.

There are many buildings and rooms which, subject to climate, require heating in the winter and cooling in the summer. These spaces are costly to maintain at the correct temperature. Of particular interest are those buildings which have glass in the roof or roof lights. For example, shopping centres where atrium roof structures create indoor streets, domestic sun rooms (conservatories), commercial and other green houses, other retail, commercial, factory warehouse and ‘aircraft hanger’ shaped structures with pitched internal ceilings. Many of these make use of the natural light which comes through the transparent part of the roof. However this is normally the place of greatest heat loss or gain depending on outside temperatures and/or position of the sun.

It is therefore desirable to provide a louvre system that acts as an effective temperature-maintaining membrane which may be used to reduce the need to heat or cool an interior space when the external temperatures become un-acceptable.

It is further desirable to enable the user of the interior space to be able to effectively turn on or off the light and heat caused by solar gain, or limit the heat loss by closing the louvre system.

### STATEMENT OF INVENTION

According to an aspect of the present invention, there is provided a louvre vane system, comprising: a frame; a plurality of vanes housed substantially in parallel within the frame; and rotating means for rotating the plurality of vanes between an open position, in which edges of adjacent vanes are spaced apart, and a closed position, in which edges of adjacent vanes abut each other to form a substantially continuous surface within the frame, wherein alternate vanes of the plurality of vanes are arranged to be rotated in opposite directions by the rotating means.

When the plurality of vanes are in the closed position, the vanes may form a substantially continuous thermally insulative barrier.

The present invention enables the user of an enclosed space or room to be able effectively to turn on or off the light and heat, or limit the heat loss by closing the louvre system. This is made considerably more effective through the firm abutment of the vanes which itself is facilitated by the alternate turning directions of adjoining vanes.

The ability to produce an open or closed suspended ceiling has the advantages of preserving both heat and light. Therefore in, for example, shopping centres where atrium roof structures create indoor streets, the present invention could be used at night to ‘close off’ the dark and prevent heat loss through the glass windows and reflect down the electric lighting to improve the ambiance of the environment. Equally, glass-roofed sunrooms are not easy to light after dark and an opening and closing suspended ceiling would significantly improve the ‘feel’ of the room after dark.

Further, some large warehouse structures are often built by property developers with an internal height of eight metres or more. However, some tenants of these buildings only use the ground level and anything above three metres is not required by them. As hot air rises, any personnel who stand no more than two metres from the ground do not get the benefit of the warmest air which is five or six metres above them. The present invention could dramatically reduce the volume of air needing to be heated or cooled and offer some air exchange with the air above the closed louvre vanes for required ventilation. In this way not only does the present invention create a membrane of improved insulation, it can do so in such a way as to significantly reduce the cubic volume of the room and therefore any heating or cooling that is required is also reduced, thereby lessening the energy required to maintain the correct temperature.

The present invention would also be advantageous for greenhouses where a significantly higher level of insulation above young plants would help early development during cold nights, and the ability to cut down direct heat through the middle of the day in summer will help to protect the plants and reduce the amount of evaporation of water and thereby reduce costs.

A further advantage of the present invention is that it can be used in tall buildings which make use of an atrium to provide natural light. These designs raise fire risk concerns as flames can sweep upwards often unimpeded. The present invention could be used to close off sections and delay the effect of smoke and flame from moving quite so quickly.

A still further advantage of the present invention is that it could also be used in a generally vertical plane to block or permit light through a window. The present invention would provide a significantly higher level of insulation than the glass alone or with curtain material.

The rotating means may comprise a rotation pulley or other system coupled to a pivot head of each of the plurality of vanes, wherein rotation of the rotation pulley may cause rotation of the pivot heads. The rotation pulley may be coupled to each pivot head by engagement with a corresponding worm screw on a shaft, wherein rotation of the rotation pulley may cause rotation of the shaft, worm screw and pivot head. Corresponding worm screws of adjacent vanes may be arranged to rotate their associated pivot heads in opposite directions.

The louvre vane system may further comprise retaining means for securing the plurality of vanes in a spaced apart position in the frame.

As an alternative, or in addition, the vanes may be turned around their pivot points by engagement between rotating means and the vanes themselves, e.g. by linkages connected to the vanes themselves.

As the vanes are held in a precise position, they can rotate and meet within a close tolerance. In this way the vanes can be closed to form a thermally sealed suspended ceiling, or open so that the vanes are anywhere between 1 and 179 degrees from the previous closed position.

The retaining means may comprise a retaining plate moveable between a locked position and a released position, wherein in the locked position, the plurality of vanes may be secured in the spaced apart position in the frame, and in the release position the plurality of vanes can be moved along the frame.

The retaining plate may have a plurality of grooves for securing the pivot heads of the plurality of vanes. The grooves may be V-shaped grooves arranged to accommodate the neck portion of each pivot head.

The retaining plate may be resiliently biased towards the released position.

The retaining means may comprise actuator means for moving the retaining plate between the locked position and the released position. The actuator means may comprise a ramp located on the retaining plate and a wheel coupled to a rod, wherein lateral movement of the rod with respect to the ramp may cause the wheel to move up and down the ramp, thereby moving the retaining plate between the locked position and the released position. The rod may be provided with a worm screw coupled to a retaining pulley, wherein rotation of the retaining pulley causes rotation of the worm screw and lateral movement of the rod.

The louvre vane system may further comprise retracting means, wherein the retracting means may be arranged to retract the plurality of vanes to one end of the frame, when the retaining plate is in the released position.

The vanes may be held in a precise position so that they can rotate and meet within a close tolerance and yet can be retracted, so all the vanes are drawn to one end of the frame. In this way the vanes can be closed forming a sealed suspended ceiling, open so that the vanes are anywhere between 1 and 179 degrees from the previous closed position or retracted so that the vanes are stacked adjacent to each other and at 90 degrees from the closed position.

The retracting means may comprise a retracting pulley and a second pulley and a retracting cord therebetween, the retracting cord coupled to the end vane farthest from the retracting pulley, such that when the retracting pulley is rotated in a first direction, the cord may move the end vane towards the retracting pulley, wherein as the end vane approaches the retracting pulley, it may engages with the other vanes such that all the vanes are urged towards the retracting pulley.

The retracting means may further comprise a number of ties coupled between adjacent vanes, such that when the retracting pulley is rotated in a second direction, the end vane may be moved away from the retracting pulley and the vane adjacent to the end vane is moved when its tie to the end vane becomes taut.

The rotating pulley, retaining pulley and retracting pulley may be arranged to be rotated by a user pulling on a cord associated with each pulley. Alternatively, the rotating pulley, retaining pulley and retracting pulley may be arranged to be rotated by motors.

The vanes may be substantially rigid. Unlike conventional roof blinds, the rigid nature of the vanes in the present invention surrounded by a frame enables the apparatus to be suspended at any angle.

Corresponding edges of adjacent vanes are provided respectively with a seal and a recess, such that when the vanes are in the closed position, the seal along the edge of one vane is located in the recess along the edge of the adjacent vane.

According to another aspect of the present invention, there is provided a louvre vane array, comprising a plurality of louvre vane systems.

A number of the above louvre vane systems can be held in close proximity to one another to form an array of frames that can be suspended from a ceiling to tessellate together to form a heat-retaining membrane (or temperature retaining membrane) across a large area. The plurality of frames may be held together by means such as nuts and bolts, or may be coupled together by other suitable means such as a hook and eye arrangement or by magnetic means, for example. The array may act to separate a roof space, which may not be needed, from the ground area, which may be. The louvre vanes can be rotated to their open position to allow in natural light if required or can be closed to help maintain a better temperature if needed.

According to another aspect of the present invention, there is provided a louvre vane system, comprising: a frame; a plurality of vanes housed substantially parallel within the frame; and rotating means for rotating the plurality of vanes between an open position, in which the edges of adjacent vanes are spaced apart and a closed position, in which the edges of adjacent vanes abut each other to form a substantially continuous surface.

According to another aspect of the present invention, there is provided a louvre vane system, comprising: a frame; a plurality of vanes housed substantially parallel within the frame; and retaining means for releasably securing the plurality of vanes in a spaced apart position in the frame, having a locked position and a released position, such that when the retaining means is in the locked position, the plurality of vanes can be rotated from an open position, in which the edges of adjacent vanes are spaced apart to a closed position, in which the edges of adjacent vanes abut each other to form a substantially continuous surface; and retracting means for retracting the plurality of vanes to one end of the frame from the spaced apart position, when the retaining means is in the released position.

The invention may comprise any combination of the features and/or limitations referred to herein, except combinations of such features as are mutually exclusive.

Embodiments of the present invention will now be described, by way of example, with reference to the accompanying drawings, in which:

FIG. 1 illustrates a louvre vane system according to an embodiment of the present invention with vanes in the closed position;

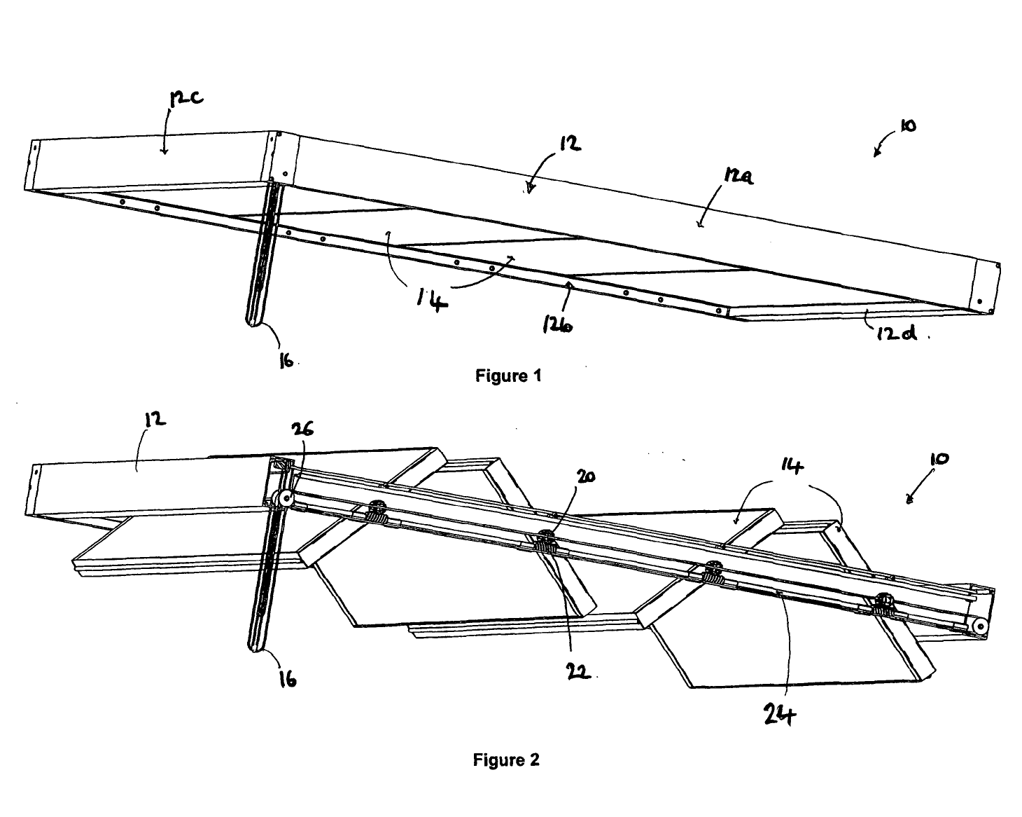

FIG. 2 illustrates the louvre vane system of FIG. 1 with the vanes in a partially open position;

FIG. 3 illustrates the louvre vane system of FIGS. 1 and 2 with the vanes in a fully open position;

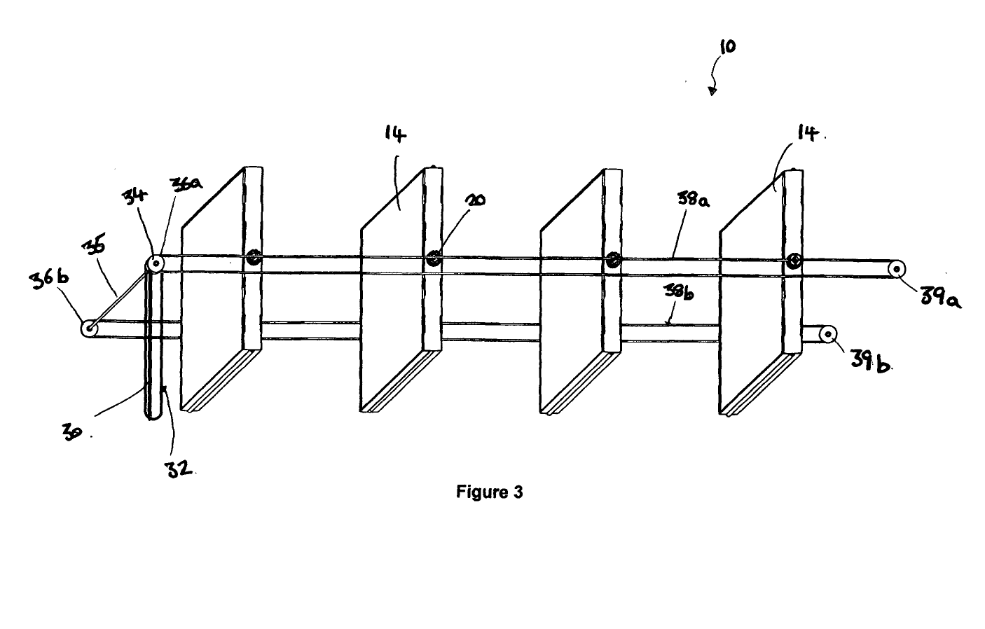

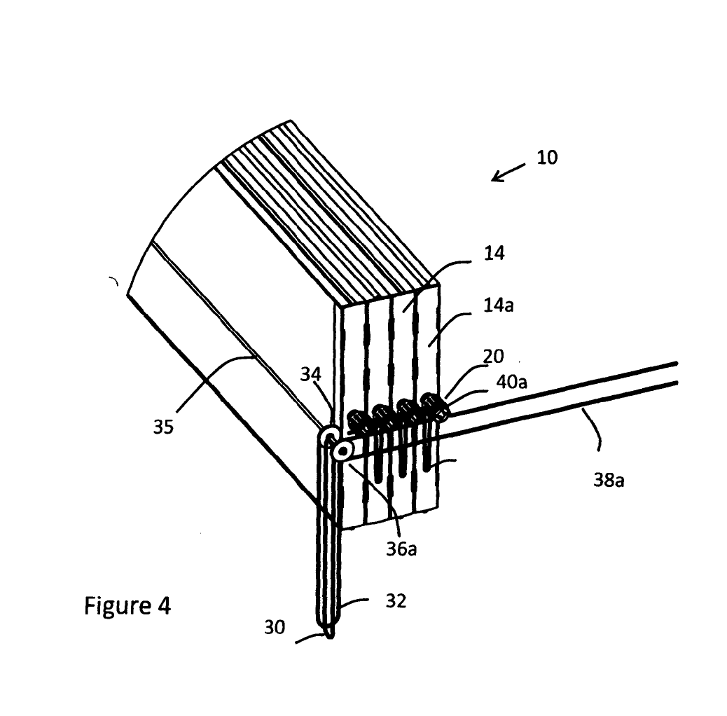

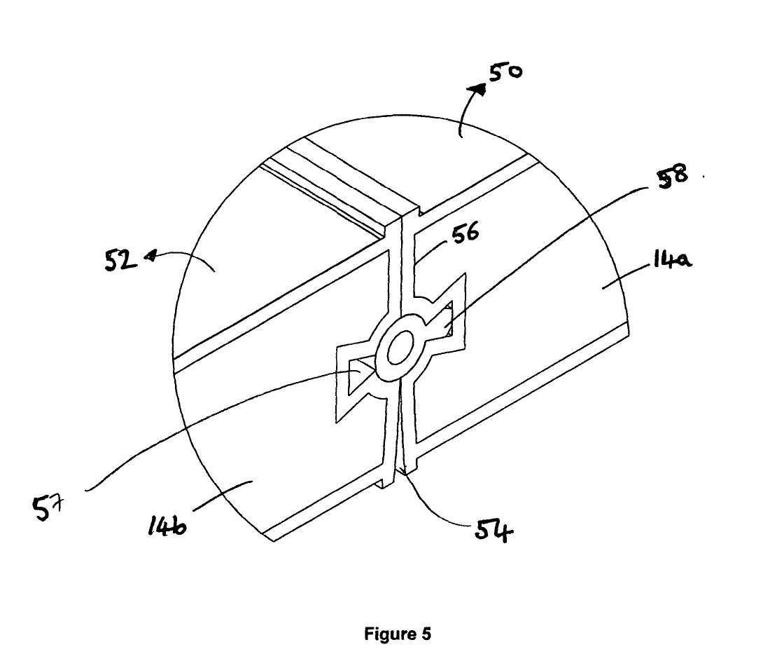

FIG. 4 illustrates a section of the louvre vane system with the vanes in a retracted position;

FIG. 5 is a cross-sectional view showing the abutment of an adjacent pair of vanes;

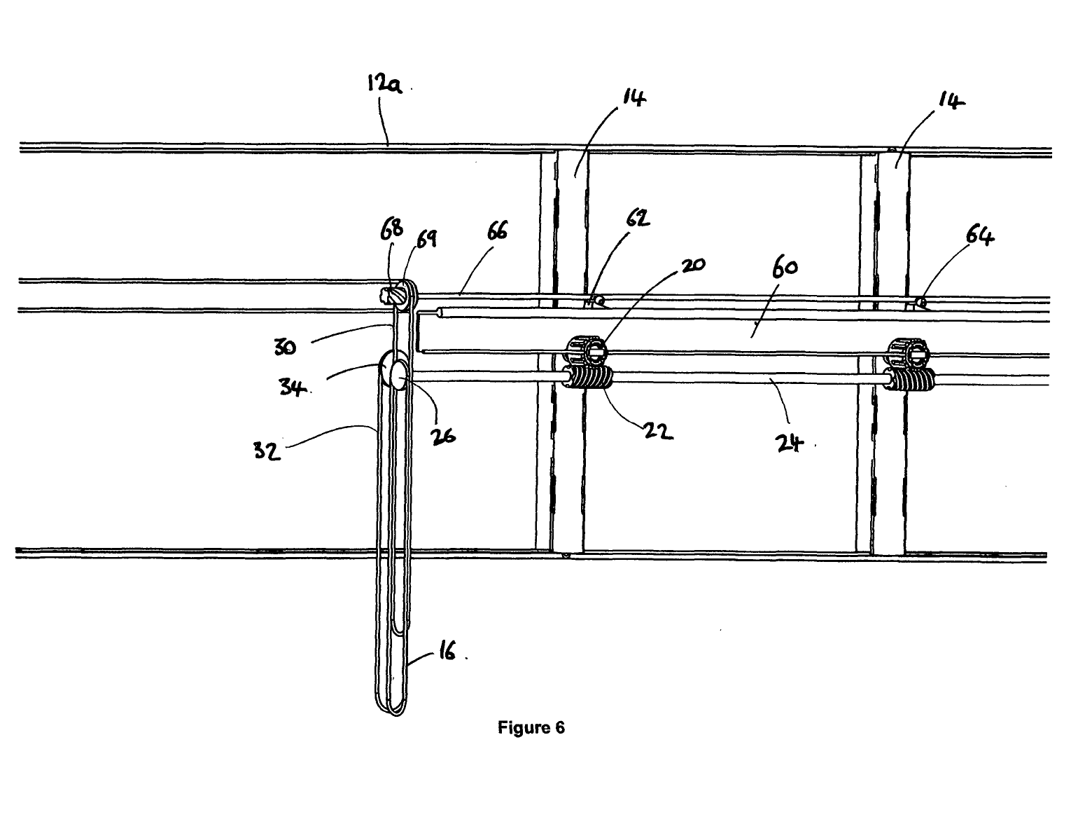

FIG. 6 is a cut-away view of the frame showing the vanes in the open position;

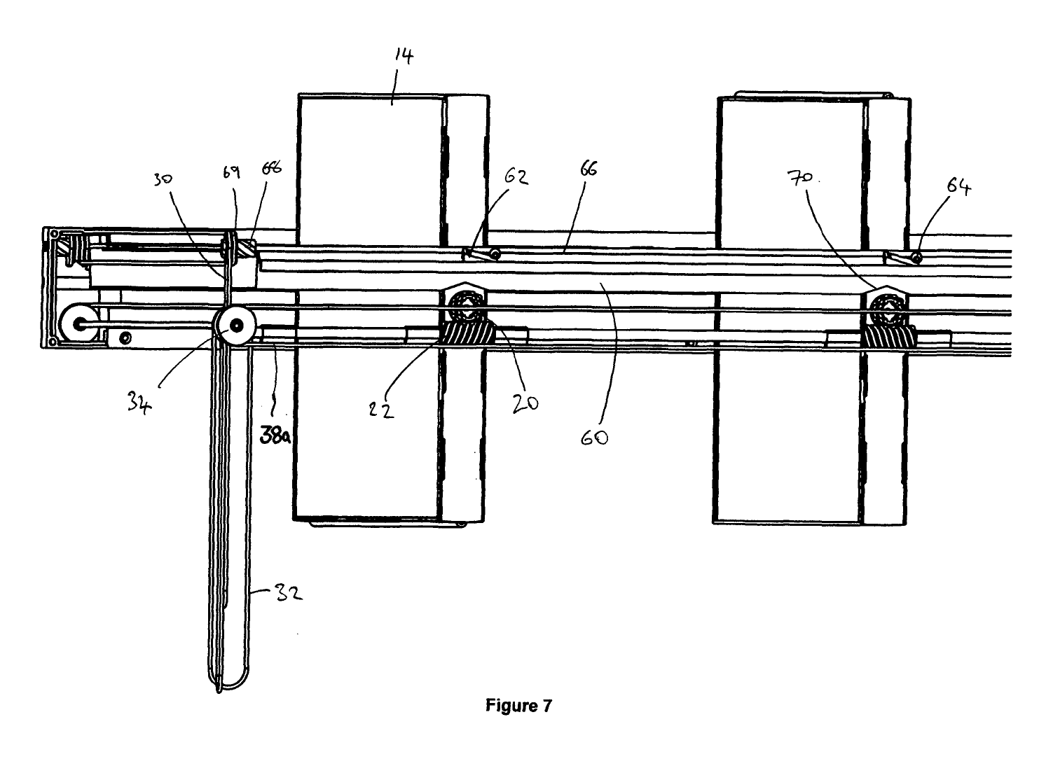

FIG. 7 is a cut-away of the frame showing a retracting mechanism;

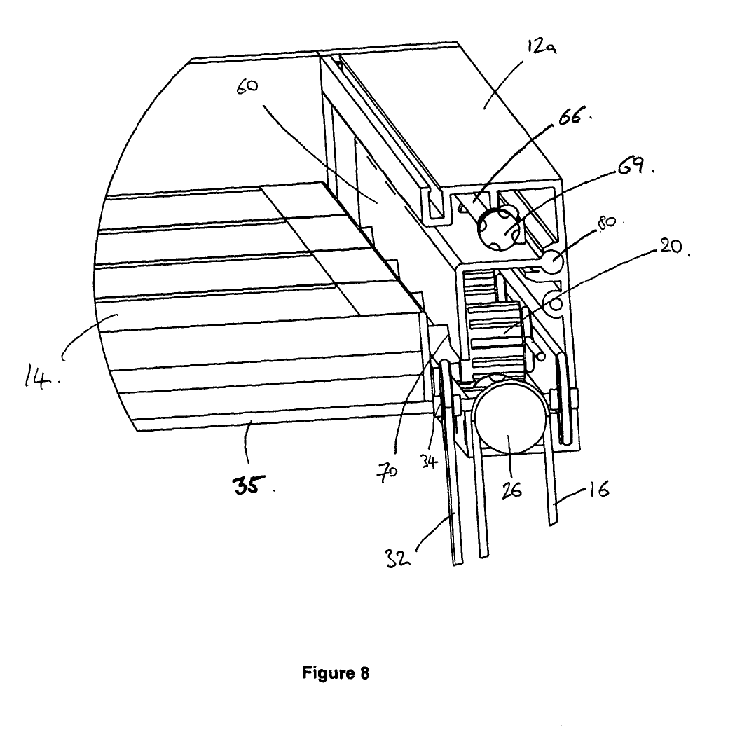

FIG. 8 is a cross-sectional view of the frame showing a configuration in which the vanes are locked in position;

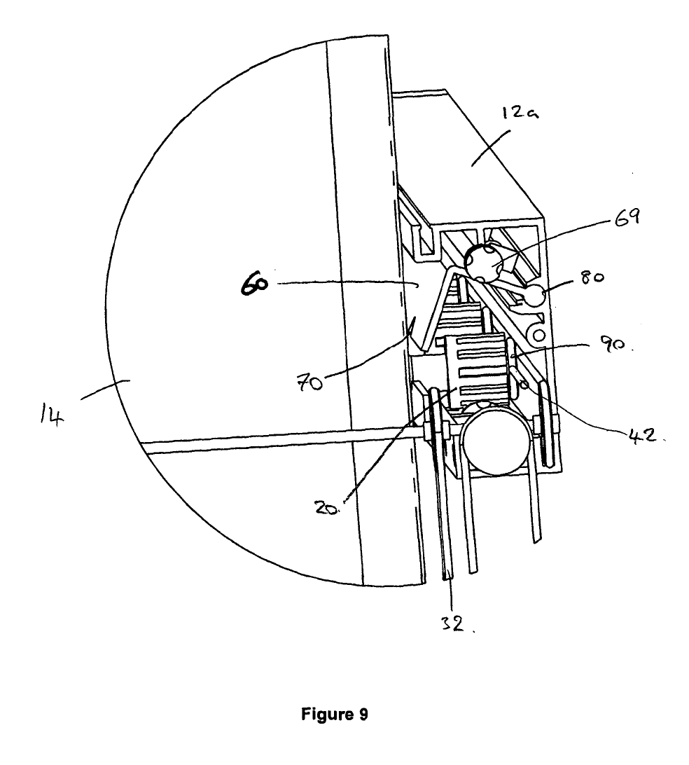

FIG. 9 is a cross-sectional view of the frame showing a configuration in which the vanes are not locked in position;

FIG. 10 is an alternate view of FIG. 9;

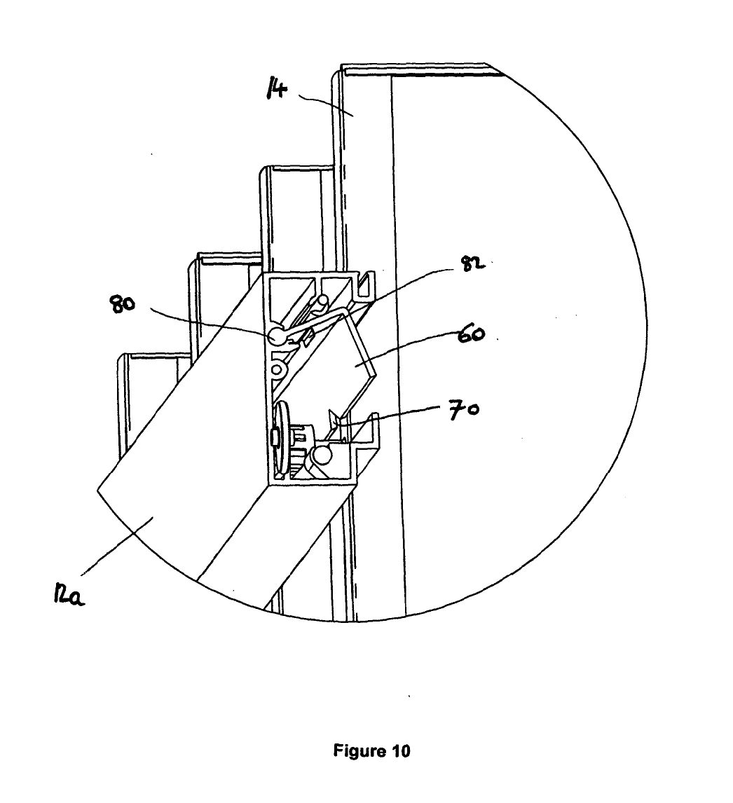

FIG. 11 shows the retaining plate in a locked position;

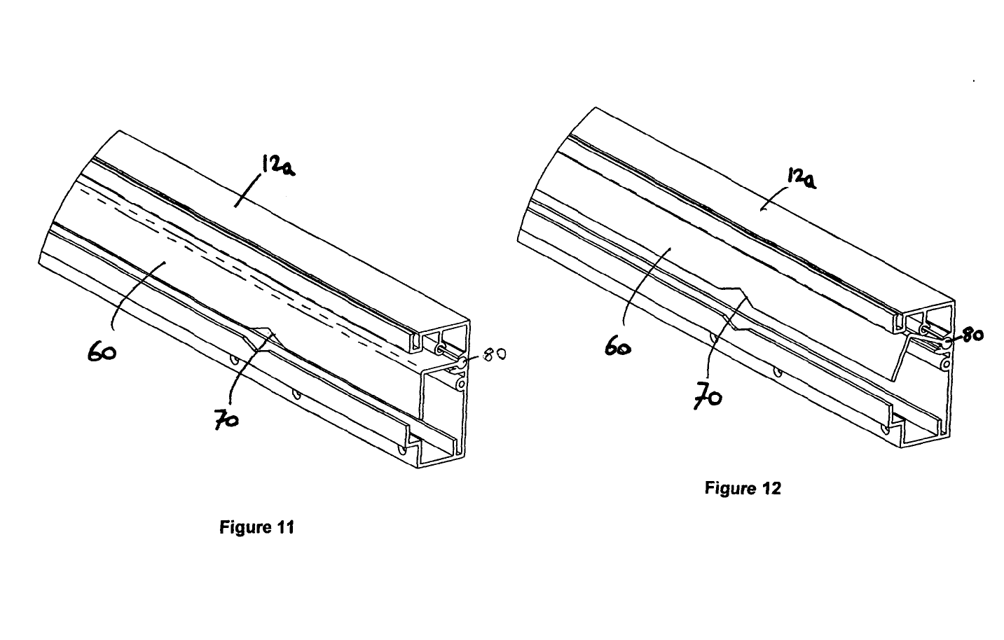

FIG. 12 shows the retaining plate in a released position;

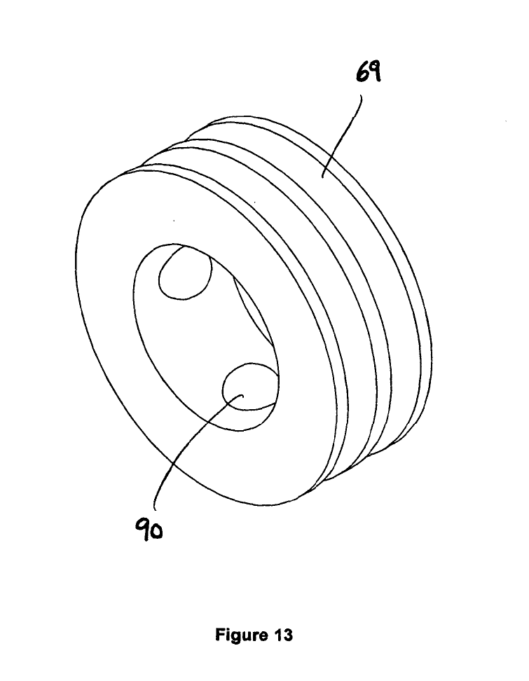

FIG. 13 shows the pulley of the retaining means;

FIG. 14 shows an alternative arrangement for rotating the vanes;

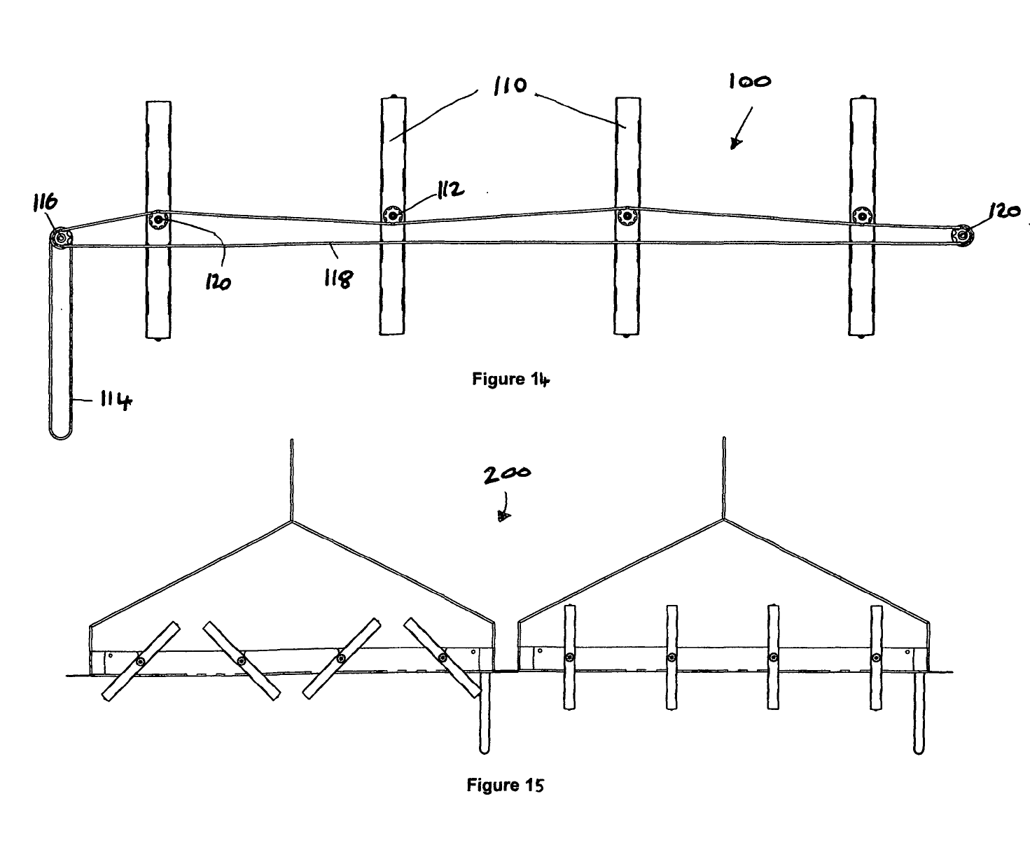

FIG. 15 shows an arrangement in which multiple frames are formed in an array.

### DESCRIPTION

FIG. 1 shows a louvre vane system 10 according to an embodiment of the present invention. The louvre vane system comprises a frame 12, which houses a plurality of the vanes or louvres 14 within the frame 12. The frame 12 comprises two side sections 12a and 12b which contain the operating mechanisms of the invention and two side sections 12c and 12d, which abut the ends of side sections 12a and 12b. Each corner of the frame 12 may be provided with an end cap, which secures the sides 12a, 12b, 12c and 12d together. Each vane 14 of the plurality of vanes is held at each end (not shown) so as to extend from a first side 12a to a second side 12b of the frame 12. Each vane 14 is capable of being rotated from an open to a closed position by a rotating means, which may be in the form of a cord 16 coupled to a pivoting axis (not shown) of each vane 14. Two further cords are shown in FIG. 1, the function of which will be described later. FIG. 1 shows the arrangement in which the vanes 14 have been rotated to a closed position, to as to form a continuous, thermally sealed surface.

As can be seen in FIG. 1, when the vanes 14 are in the closed position, adjacent vanes abut each other, such that there are no air gaps between the adjacent vanes 14. Also, the vanes 14 are arranged within the frame 12 such that there are no air gaps around the edge of the vanes that are located in proximity to the frame 12. The vanes 14 are retained at both ends such that that when they are in the closed position, the edges that are adjacent to the frame 12 are also provided with draft proof contacts so that one side of the membrane is insulated from the temperature on the other side of the membrane.

Each vane 14 may be extruded from plastics or aluminium and then filled with an insulation material such as polyisocyanurate, to provide rigid, thermally insulating vanes. As would be appreciated by the skilled person, the vanes 14 could be made of any material, or have any construction, that provides rigid vanes that are capable of forming a thermally insulting layer.

When the vanes 14 are in the closed position, as in FIG. 1, the thermal membrane that is formed by the vanes 14, is a solid layer due to the rigidity of the vanes and the close abutment of the vanes. In other words, when the vanes are in the closed position, a thermal membrane is formed by the vanes 14 that prevents drafts and limits heat exchange from one side of the membrane to the other.

In the present invention, as each of the vanes 14 may be in the region of 3 m in length or longer, in order to effectively prevent draft or heat exchange it is desirable that the vanes snap closed and are not permitted to simply rest against one another such that a small amount of airflow would separate them and permit a breach in the membrane.

In order to achieve this, it is desirable to rotate adjacent vanes 14 in opposed directions. For example, a first vane is rotated in a first direction, for example clockwise, and the adjacent vane is rotated in the opposite direction, for example anti-clockwise. As the vanes 14 are rotated, the edges of each vane are arranged to come together to form a close abutment. One advantageous effect of the alternately opposed rotational movement of the vanes 14, is that it allows each vane to hold each of the two adjacent vanes that it abuts in the closed position until they are positively disengaged by appropriate rotation of the rotating means. This positive disengagement could not be achieved if all the vanes were to be rotated in the same direction, as is the case with conventional blinds.

However, although the above mentioned positive disengagement could not be achieved if all the vanes were to be rotated in the same direction, it is envisaged that a membrane with adequate thermal properties could be provided with an arrangement in which all vanes are rotated in the same direction (although this may be more expensive to achieve).

FIG. 2 shows the louvre vane system 10 with the side portion 12a of the frame 12 cut away to show the rotating mechanism. In FIG. 2, the vanes 14 have been rotated from the closed position of FIG. 1 to a partially open position. As can be seen in FIG. 2, alternate vanes are rotated in opposite directions, as described above.

Each of the plurality of vanes 14 is rotated around a pivoting head 20. Each pivoting head has engaging means such as gear teeth on its exterior for engagement with worm screws 22. The worm screws 22 are fixed onto a shaft 24, which is coupled to the rotation cord 16 via a pulley or gear mechanism 26. By pulling the rotation cord 16, the shaft 24 can be rotated. In an alternative embodiment, movement of the rotation cord 16 may be transferred to the shaft 24 through a lay gear.

In order to achieve the alternate rotation of the vanes 14 as described above, the worm screws 22 may be alternately threaded right hand or left hand so that when the shaft 24 is rotated, for example, clockwise a first worm screw on the shaft 24 will turn its associated vane 14 clockwise and the adjacent worm screw will turn its associated vane 14 anti-clockwise.

FIG. 3 shows the vane louvre system 10 in which the vanes 14 have been rotated from the partially open position of FIG. 2 to the fully open position. In FIG. 3, the retracting mechanism is shown.

The retracting mechanism comprises a number of cords and pulleys which control the movement of the vanes 14. The retracting mechanism allows for the vanes to be moved along the frame to one end of the frame.

A release cord 30 operates a lever mechanism (not shown) which opens to release the vane pivot heads 20 so that the vanes 14 can be retracted by a retracting cord 32. The mechanism by which the vane pivot heads 20 are held in position and released will be described later. The following description of FIG. 3 is in the situation in which the vane pivot heads 20 are released.

The retracting cord 32 may be pulled either left hand or right hand down to turn the drive pulley 34 which is coupled to shaft 35. Also coupled to shaft 35 are two pulleys 36a and 36b. Pulley 36a is coupled with a drive cord 38a which is held taut around a pulley 39a at the far end of the array of vanes 14. Pulley 36b is coupled with a drive cord 38b which is held taut around a pulley 39b at the far end of the array of vanes 14.

The cords 38a and 38b are attached to the vane 14n furthest from pulley 34. When the cord 32 is pulled in a first direction (anti clockwise in this example), the vane 14n will be moved by the cords 38a, 38b towards the pulley 34 and away from the pulleys 39a, 39b.

When vane 14n is moved by the cords 38a, 38b towards the pulley 34, it will come into contact with the next vane in the array and also cause it to move towards the pulley 34, and so on with all of the vanes in the array. In other words, when the retracting cord 32 is pulled, the vanes are retracted from their operational position to their retracted position at one end of the frame 12.

FIG. 4 shows the louvre vane system 10 in which the vanes 14 are fully retracted to one end of the frame 12 (not shown). This view better shows the drive pulley 34 and the pulley 36a coupled to the shaft 35.

FIG. 4 also shows coupling means 40a, by which the vane 14n furthest from shaft 35 is attached to the cord 38a. Though not shown in FIG. 4, a similar coupling means 40b is provided on the opposite side of vane 14n for coupling vane 14n to cord 38b.

Also shown in FIG. 4 are ties 42 in their non taut state. The ties 42 are attached to the pivot head 3 of each vane. These ties 42 are dimensioned to fit between each vane 14 to allow the vanes to be pulled back into an operational position.

When the cord 32 is pulled in the second direction (clockwise in this example), the vane 14n will be moved by the cords 38a, 38b away from the pulley 34 and towards the pulleys 39a, 39b. The vane 14n will be the only vane to be moved by the cords 38a, 38b, until the tie 42 between the vane 14n and its adjacent vane becomes taut. Then both vanes will move, and so on until all vanes are located in their operation position with the ties in between the vanes being taut.

FIG. 5 shows a view of abutment of two vanes 14a, 14b in the closed position. It is desirable that edge of the vanes be shaped to co-operate in order to create an airtight fit and prevent drafts or heat exchange between edges of the vanes.

In FIG. 5, the vanes 14a, 14b are configured such that their abutting edges rotate away from each other in the directions 50 and 52. As can be seen in FIG. 5, the edge of the vanes 14a, 14b is chamfered at its lower edge to facilitate the rotation in the directions 50, 52 and back again while allowing the edges of each vane 14a, 14b in the region 56 to be at right angles to each other. This allows a close abutment and a resistance to over rotation.

In order to provide the necessary close abutment of the edges of adjacent vanes 14a, 14b, the lower portions of the edges of the vanes are chamfered. This prevents a collision that would occur as the edges approached each other, due to the opposing rotation of the two adjacent vanes. A space 54 between the lower edges of the vanes 14a, 14b is created when the vanes are in the closed position. This space 54 facilitates the rotation of the vanes from the closed position. This design and movement of the vanes optimises contact of the edges of the vanes to maintain the best thermal barrier, while maintaining free rotation of the vanes.

A further feature within edge of each vane is a recess 57 that may contain a flexible seal member 58. Preferably, the seal member is positioned at the midway point along edge of the vane.

In the situation in which the vanes 14a and 14b are being moved from the open position to the closed position, as the edges of the vanes 14a, 14b come together the flexible seal member 58 locates into the opposing recess and forms a positive engagement and sealing.

FIG. 6 is a cutaway of the side portion 12a of frame 12. Two vanes 14 are shown in the open position. Each vane rotates about a pivot head 20, which has a plurality of gear teeth for engagement with a worm screw 22. The worm screws 22 are fixed to a shaft 24 which can be rotated by a user pulling on rotation cord 16 which is coupled to a pulley 26 which is in turn coupled to the shaft 24. In the example shown in FIG. 6, the worm screws 22 are arranged on the shaft 24 such that first vane 14 in the array turns, by way of example only, left hand down and the next one turns right hand down. This turns the vanes clockwise and anti-clockwise, as described above. The worm screw shaft 24 is allowed to freely rotate and is coupled to the frame section 21a by means of a fixing (not shown). The fixing may be any means suitable for retaining the shaft 24 in position, while allowing it to freely rotate.

The gear teeth of the pivot heads 20 are held in engagement with worm screw 22 by a retaining plate 60. The retaining plate 60 holds pivot heads 20 in a fixed position by engagement with V-grooves (not shown in FIG. 6) provided in the retaining plate 60. FIG. 6 shows the retaining plate 60 in the locked position, where the V-grooves of the retaining plate 60 hold neck portions of the pivot heads 20 in a secure position.

The retaining plate 60 includes an actuator means which is arranged to move the retaining plate between the locked and released positions, in which the V-grooves of the retaining plate 60 do not hold neck portions of the pivot heads 20 in a secure position. The actuator means may includes ramps 62 which remain in contact with wheels 64 which are retained on rod 66. In order to retain or release the vanes 14 at pivot points, the retaining plate 60 is biased by a spring (not shown) towards the released position.

Rod 66 may be moved in relation to retaining plate 60 by worm screw 68 and pulley 69. The worm screw 68 is fixed to the rod 66 and is coupled to an interior surface of the pulley 69 by teeth. The pulley 69 is held in position within the frame such that it is prevented from any lateral movement, but is able to rotate freely. When the pulley 69 is rotated by a user pulling on cord 30, rotation of the pulley 69 rotates the worm screw 68 by engagement between the worm screw and the internal teeth of the pulley, which causes the worm screw to move laterally with respect to the pulley 69. As the rod 66 is coupled to the worm screw 68, the lateral movement of the worm screw 68 is translated into lateral movement of the rod 66 in relation to the pulley 69 and retaining plate 60. In the configuration shown in FIG. 6, as the rod 66 is moved to the right by a user pulling on the release cord 30, the wheels 64 will move down the ramps 62. When the wheels 64 are moved sufficient distance that they are free of the ramps 62, the spring that is biasing the retaining plate 60 will act to bias the retaining plate in the open position.

Likewise, in order to lock the retaining plate 60 back into the locked position, a user pulling on the release cord 30 will rotate the rod 64 and cause it to move to the left, thereby causing the wheel to engage with, and move up the ramps 62, such that the retaining plate 60 is moved to the locked position against the spring bias.

As would be understood by the skilled person, an alternative rack could be used instead of worm screw and a pinion gear could be used instead of teeth on the pulley, in the release mechanism. Also, instead of the wheel 64, ramp 62 and worm screw 68 arrangement shown in FIG. 6, the rod 66 could be directly coupled to a cam arrangement, which is operable to lift and lower the rod 66 and hence move the retaining plate 60 between the locked and release positions.

FIG. 7 shows a similar view to FIG. 6, but FIG. 7 shows the situation where the retaining plate 60 is in the released position. In FIG. 7, the pulley 69 has been rotated by pulling the release cord 30, which has moved the rod 66 through the lateral movement of worm screw 68. This in turn has moved the wheels 64 such that they are no longer in contact with ramps 62, such that the retaining plate 60 is moved to its released position by the biasing spring.

Retaining plate 60 includes a plurality of V-shaped grooves 70. In FIG. 7, the V-grooves 70 no longer hold the necks of pivot heads 20, which are now free to move laterally within frame 12. As will be apparent to the skilled person, this arrangement may be repeated within both sections 12a and 12b of the frame 12. In this situation, the pulley 69 may be coupled to an associated pulley in section 12b such that the turning of pulley 69 by the release cord 30 also rotates the corresponding pulley in section 2b. Alternatively, an additional release cord may be provided.

When the retaining plate 60 has been biased into the open position, as shown in FIG. 7, the user is able to use the retracting cord 32 to retract all the vanes 14 to one end of frame 12, as described above in relation to FIGS. 3 and 4. FIG. 7 shows the retracting system of FIG. 3 incorporated with the release system.

The retracting system comprises retracting cord 32, which rotates pulley 34 which, being a double pulley, moves cord 38a which is coupled to the vanes 14 as described in relation to FIG. 3.

The cord 38a is connected to the vane 14n furthest from the pulley 34 and, being the furthest vane from the end of the frame to which all the vanes are to be retracted, when this pulley system is operated by the user, the retracting cord 32 pulls the furthest vane 14n towards pulley 34, in doing so it will in turn come into contact with the second furthest vane and then the next vane in the array in turn, causing all vanes to be drawn towards the end of the frame which houses pulley 34. When the user wishes to return the vanes to their retained positions, retracting cord 32 is pulled in the other direction and this pulls the furthest vane back away from the pulley 34. In order that all the vanes are returned to their correct positions there is provided tie 42 which is connected between each of the vanes so that when the vane 14n is pulled by retracting cord 32, it will then draw along the next vane in the array as soon as fixed tie 42, which is made of flexible material, becomes taut. Continued pulling of vane 14n causes all the vanes 14 to be returned to the position where the retaining plate 60 with its V-grooves 70 will retain the necks of the pivot heads 20 and hold the vane 14 in the correct position for rotation by the worm screw 22 against the teeth of the pivot heads 20.

FIG. 8 shows a cutaway of the frame section 12a. FIG. 8 shows the retaining plate 60 in the locked position, in which the V-grooves 70 secure the necks of the pivot heads 20.

FIG. 8 also shows more clearly the arrangement of the three user-operated pulley systems.

The rotation cord 16 is coupled to the pulley 26. The release cord 30 (not shown) is coupled to the pulley 69. The retracting cord 32 is coupled to the pulley 34.

As described above, pulling the rotation cord 16 turns pulley 26, which in turn rotates the worm screws 22 which turns the pivot heads 20 of the vanes 14. Pulling the release cord 30 turns pulley 69, which rotates the worm screw 68 and its rod 66, causing them to move and thereby release the retaining plate 60, so that bias spring bias the plate into its released position. As can be seen in FIG. 8, the retaining plate 60 is allowed limited rotation through axis 80. Pulling retracting cord 32 turns the pulley 34, which in turn pulls a further cord 38a which retracts the vanes 14 by pulling the furthest vane 14n towards the pulley 34. A rod 35, which runs the length of the vane 14, may be provided to operate a duplicate system of cords and pulleys at both ends of the vanes 14.

FIG. 9 shows a view of the frame section 12a in which the retaining plate 60 is in the released position, rotating about axis 80. As the V-grooves 70 no longer secure the necks of the pivot heads in position, the vanes 14 can be retracting by pulling the retracting cord 32.

Also shown in FIG. 9 is a tie 42, which connects one vane 14 to the next adjacent vane. Each tie 42 is of fixed length and connects to the vane by a ring 90. The ring 90 is rotatably coupled to the pivot head 20. The ring 90 allows the pivot head 20 to rotate, while tie 42 remains taut.

FIG. 10 is an alternative view of the arrangement shown in FIG. 9, in which the retaining plate has been moved to its release position. FIG. 10 also shows a spring 82 which acts to bias the retaining plate 60 into the released or open position. The spring may be a leaf spring, coil spring or any other element suitable to resiliently bias the retaining plate in the released or open position.

FIG. 11 Shows a view of the frame section 12a in which only the retaining plate 60 is shown. In FIG. 11, the retaining plate is in the locked position. FIG. 12 shows the retaining plate 60 in the released position.

FIG. 13 shows pulley 69 which is used in the retaining means. Pulley 69 includes a plurality of teeth/bumps/protrusions/dogs 90 on its internal surface, which engage with the worm screw 68 (not shown). In use, a cord 30 (not shown) is coupled to the pulley 69 such that a user pulling cord 30 causes the pulley 69 to rotate.

Rotation of the pulley 69 rotates the worm screw 68 by engagement between the worm screw and the internal teeth 90 of the pulley. This causes the worm screw to move laterally with respect to the pulley 69. As a rod 66 (not shown) is coupled to the worm screw 68, the lateral movement of the worm screw 68 is translated into lateral movement of the rod 66 in relation to the pulley 69.

As an alternative, a rack could be used instead of worm screw 68 and a pinion gear could be used instead of teeth 90 on the internal surface of the pulley.

FIG. 14 shows a further and simpler embodiment of the invention where there is no requirement to retract the vanes to one side. In this embodiment, it is only necessary to provide a means for rotating the vanes between their open and closed positions, and the retracting and release mechanisms can be dispensed with.

FIG. 14 shows a louvre vane system 100 with a plurality of vanes 110. Each vane 110 has a pivot head 112, about which it can rotate. A rotation cord 114 is provided to operate the rotating (opening and closing) of the vanes 110. Pulling the cord 114 rotates a pulley 116, on which is also fixed a drive sprocket. The drive sprocket is fitted with chain 118 which connects with all the vanes 110 in the array by sprockets 120 on their pivot heads.

In order to drive the vanes in opposing directions the chain 118 is linked, for example, on the left hand side of the sprocket on the first vane in the array and then on the right hand side of the next sprocket in the array and so on. The chain 118 is taken around a sprocket 120 which is situated at the far end of section frame section 12a (not shown) so that the chain can be retuned in a straight line to form a loop. In this embodiment, if a single length of cord 114 is pulled, the vanes 110 may be rotated from a closed position and vice versa.

FIG. 15 shows a louvre vane array 200, in which a number of frames containing a plurality of vanes are provided. These frames may be the frames of the embodiment described in FIGS. 1 to 12, or they may be of the embodiment shown in FIG. 13, or any combination thereof.

The frames can be suspended from a ceiling and may be connected by solid means such as a nut and bolt or biased to stick together by magnetic means. This method of mounting an array of vanes in a roof space is suitable where the user of a hanger style warehouse building, which may be 8 m tall, is occupied by a user who only requires 4 m in height. In such a case a number of frames can be suspended from the ceiling to tessellate together to form a heat-retaining membrane separating the roof space, which is not needed, from the ground area which is. The louvre vanes can be rotated to their open position to allow in natural light if required or can be closed to help maintain a better temperature if needed.

The frame may be secured within a framework below the present ceiling of a room or building. As the vanes of the present invention are rigid, the angle of the frame in relation to the ground may vary from being generally horizontal to generally vertical.

In the above description, as will be apparent to the skilled person, where a cord is used, a chain or other member may also be used. Also, where a pulley is used, a sprocket or other gear member may also be used. While the description describes the rotation, release and retraction mechanism in one frame section 12a, it should be understood that corresponding mechanism may be provided in the opposite frame section 12b. This may be provided by translating the movement of the cords on one side of the frame to the other. Alternatively, the side 12b may be provided with its own control cords.

Further, it is also possible for each drive pulley to be motor driven so that the vanes may be rotated and/or retracted remotely. Further still, these motors could be linked to heat sensors so that the vanes are opened and closed automatically by a smart actuator based on light, heat or fumes (in the event of fire).

Whilst endeavouring in the foregoing specification to draw attention to those features of the invention believed to be of particular importance, it should be understood that the applicant claims protection in respect of any patentable feature or combination of features hereinbefore referred to and/or shown in the drawings whether or not particular emphasis has been placed thereon.

1-24. (canceled)

25. A louvre vane system, comprising:
a frame;
a plurality of vanes housed substantially in parallel within the frame; and
rotating means for rotating the plurality of vanes between an open position, in which edges of adjacent vanes between an open position, in which edges of adjacent vanes are spaced apart, and a closed position, alternate vanes of the plurality of vanes being arranged to be rotated in opposite directions by the rotating means, and wherein the edges of the adjacent vanes are shaped to co-operate in creating an airtight fit, whereby, in the closed position, the edges abut each other to form a substantially continuous thermally insulative barrier within the frame.

26. The louvre vane system of claim 25, wherein each vane has, at at least one end, a pivot head, and wherein the rotating means comprise a rotation pulley coupled to the pivot head of each of the plurality of vanes, such that rotation of the rotation pulley causes rotation of the pivot heads.

27. The louvre vane system of claim 26, wherein the rotation pulley is coupled to each pivot head by engagement with a corresponding worm screw on a shaft, wherein rotation of the rotation pulley causes rotation of the shaft, worm screw and pivot head.

28. The louvre vane system of claim 25, wherein corresponding worm screws of adjacent vanes are arranged to rotate their associated pivot heads in opposite directions.

29. The louvre vane system of claim 25, further comprising a retaining means for securing the plurality of vanes in a spaced apart position in the frame.

30. The louvre vane system of claim 29, wherein the retaining means comprises a retaining plate moveable between a locked position and a released position, wherein in the locked position, the plurality of vanes are secured in the spaced apart position in the frame and in the release position, the plurality of vanes can be moved along the frame.

31. The louvre vane system of claim 30, wherein the retaining plate has a plurality of grooves for securing the pivot heads of the plurality of vanes.

32. The louvre vane system of claim 31, wherein the grooves are V-shaped grooves arranged to accommodate the neck portion of each pivot head.

33. The louvre vane system of claim 30, wherein the retaining plate is resiliently biased towards the released position.

34. The louvre vane system of claims 29, wherein the retaining means comprises actuator means for moving the retaining plate between the locked position and the released position.

35. The louvre vane system of claim 34, wherein the actuator means comprises a ramp located on the retaining plate and a wheel coupled to a rod, wherein lateral movement of the rod with respect to the ramp causes the wheel to move up and down the ramp, thereby moving the retaining plate between the locked position and the released position.

36. The louvre vane system of claim 35, wherein the rod is provided with a worm screw coupled to a retaining pulley, wherein rotation of the retaining pulley causes rotation of the worm screw and lateral movement of the rod.

37. The louvre vane system of claim 30, further comprising retracting means, wherein the retracting means are arranged to retract the plurality of vanes to one end of the frame, when the retaining plate is in the released position.

38. The louvre vane system of claim 37, wherein the retracting means comprises a retracting pulley and a second pulley and a retracting cord therebetween, the retracting cord being coupled to the end vane farthest from the retracting pulley, such that when the retracting pulley is rotated in a first direction, the cord moves the end vane towards the retracting pulley, wherein as the end vane approaches the retracting pulley, it engages with the other vanes such that all the vanes are urged towards the retracting pulley.

39. The louvre vane system of claim 38, wherein the retracting means further comprises a number of ties coupled between adjacent vanes, such that when the retracting pulley is rotated in a second direction, the end vane is moved away from the retracting pulley and the vane adjacent to the end vane is moved when its tie to the end vane becomes taut.

40. The louvre vane system of claim 25, wherein the vanes are substantially rigid.

41. The louvre vane system of claim 25, wherein corresponding edges of adjacent vanes are respectively provided with a seal and a recess, such that when the vanes are in the closed position, the seal along the edge of one vane is located in the recess along the edge of the adjacent vane.

42. The louvre vane system of claim 25, wherein corresponding edges of adjacent vanes are chamfered.

43. A louvre vane array, comprising a plurality of louvre vane systems according to claim 25.
